(19) United States
(12) Patent Application Publication
(10) Pub. No.: US 2024/0219530 A1
(43) Pub. Date: Jul. 4, 2024

(54) LASER DETECTOR AND LIDAR

(71) Applicant: SUTENG INNOVATION TECHNOLOGY CO., LTD., Shenzhen (CN)

(72) Inventors: Jie LUO, Shenzhen (CN); Huazhou CHEN, Shenzhen (CN); Shen JIANG, Shenzhen (CN)

(73) Assignee: SUTENG INNOVATION TECHNOLOGY CO., LTD., Shenzhen (CN)

(21) Appl. No.: 18/395,702

(22) Filed: Dec. 25, 2023

(30) Foreign Application Priority Data
Dec. 29, 2022 (CN) 202211703207.6

(51) Int. Cl. G01S 7/4863

(52) U.S. Cl. CPC G01S 7/4863

(57) ABSTRACT

This application pertains to the field of laser detection, and specifically, relates to a laser detector, including multiple optical detection units and a received signal processing module, where the multiple optical detection units are divided into at least a first block and a second block, a first bias voltage is input into each optical detection unit in the first block, a second bias voltage is input into each optical detection unit in the second block, and the first bias voltage is different from the second bias voltage. The received signal processing module is configured to process a received incident optical signal detected by the first block and the second block and provide an output signal.

### CROSS-REFERENCE TO RELATED APPLICATION

The present application claims the benefit of priority to Chinese Patent Application No. 202211703207.6, filed on Dec. 29, 2022, which is hereby incorporated by reference in its entirety.

### TECHNICAL FIELD

The present application relates to the field of LiDAR, and in particular, to a laser detector and a LiDAR.

### TECHNICAL BACKGROUND

With complex and variable actual vehicle driving environments, to implement high-level autonomous driving functions, higher requirements are imposed on sensing and detection capabilities of a vehicle-mounted LiDAR, including, a greater detection range, no blind region in short-distance ranging, and distinguishability of reflectivities of objects at different distances. Currently, a Time of Fight (TOF) technical solution is generally used for the LiDAR. A pulse laser beam is emitted in a target direction, and a reflected laser beam from the object is received by a detector. TOF of a laser beam pulse between the LiDAR and the target and intensity and a shape of a reflected echo are measured, information indicating whether there is an object in the target direction, a distance from the object to the LiDAR, and reflectivity of an object surface can be obtained.

A laser detector is a core device in the TOF solution, and determines detection efficiency, detection resolution and a dynamic detection range in a photoelectric conversion process. There is still room for improvement of existing laser detectors.

### SUMMARY

This application provides a laser detector, including multiple optical detection units and a received signal processing module. The multiple optical detection units are divided into at least a first block and a second block, a first bias voltage is input into each optical detection unit in the first block, a second bias voltage is input into each optical detection unit in the second block, and the first bias voltage is different from the second bias voltage; and the received signal processing module is configured to process a received incident optical signal detected by the first block and the second block and provide an output signal.

In an embodiment, outputs of the optical detection unit in the first block are combined into a first detection signal for outputting; and outputs of the optical detection unit in the second block are combined to output a second detection signal; and
the received signal processing module includes a first receiving circuit for processing the first detection signal and a second receiving circuit for processing the second detection signal.

In an embodiment, the first bias voltage is higher than the second bias voltage, and when the first block outputs a saturated echo signal, the received signal processing module obtains information of an echo signal via the second detection signal output by the second block by excluding the saturated echo signal output by the first block; or the received signal processing module obtains information of an echo signal via the second detection signal output by the second block and a rising edge and/or saturation width of the saturated echo signal output by the first block.

In an embodiment, an output of at least some optical detection units in the first block and an output of at least some optical detection units in the second block are combined into a third detection signal for outputting; and the received signal processing module includes a third receiving circuit for processing the third detection signal.

In an embodiment, the multiple optical detection units further include a third block, a third bias voltage is input into each optical detection unit in the third block, and the third bias voltage is different from the first bias voltage and the second bias voltage;
outputs of optical detection units in the third block are combined into a fourth detection signal for outputting; and
the received signal processing module includes a fourth receiving circuit for processing the fourth detection signal.

In an embodiment, the first block or the second block includes at least two sub-blocks, outputs of different sub-blocks are combined into different detection signals for outputting, and outputs of optical detection units in the same sub-block are combined into the same detection signal for outputting.

In an embodiment, the optical detection units in the same block are connected in parallel to combine outputs into a detection signal and output the detection signal to the receiving circuit;
the optical detection units in the same block convert their respective excited currents into pulse signals, combine the pulse signals into a detection signal via a logic combination circuit and output the detection signal to the receiving circuit; or
the optical detection units in the same block convert their respective excited currents into pulse signals, combine the pulse signals into a detection signal via analog circuit addition and output the detection signal to the receiving circuit.

In an embodiment, the multiple optical detection units include multiple blocks, and input bias voltages of two adjacent blocks are different.

In an embodiment, the laser detector includes multiple first blocks and multiple second blocks, and the multiple first blocks and the multiple second blocks are alternately arranged in a checkerboard pattern.

In an embodiment, the second bias voltage is lower than the first bias voltage, and the optical detection units in the second block are arranged around the first block.

In an embodiment, the second block and the first block are arranged side by side; or the second bias voltage is lower than the first bias voltage, the laser detector includes at least two second blocks, and the at least two second blocks are respectively arranged on different sides of the first block.

In an embodiment, resolution of the first block is greater than that of the second block.

In an embodiment, an input bias voltage of at least one block in the multiple optical detection units has a value, so that the block works in a linear mode.

In an embodiment, the multiple optical detection units include an SiPM and a SPAD array.

This application further provides LiDAR, including a laser emitter for emitting a laser beam and the laser detector according to any one of the foregoing embodiments.

In the embodiments of this application, the multiple optical detection units are arranged in the laser detector, and the multiple optical detection units are arranged into at least two blocks with different input bias voltages, which can ensure different detection efficiencies and implement greater dynamic detection range. The block providing a high bias voltage has high photoelectric conversion efficiency and great gains, and is suitable for measurement of weak light (for example, an echo from a long distance with low reflectivity); and the block providing a low bias voltage has low photoelectric conversion efficiency and small gains. When the bias voltage is sufficiently low, the block may even degrade to work in the linear mode, and the block has smaller photoelectric conversion efficiency and gains, and is suitable for measurement of strong light, for example, an echo from a short distance or with high reflectivity.

### BRIEF DESCRIPTION OF DRAWINGS

FIG. 1 is a schematic diagram of an embodiment of a laser detector according to an embodiment;

FIG. 2 is a schematic structural diagram of an SiPM according to an embodiment;

FIG. 3 is a schematic structural diagram of a SPAD according to an embodiment;

FIG. 4 is a schematic diagram of an arrangement of different blocks in a laser detector according to an embodiment;

FIG. 5 is a schematic diagram of an arrangement of different blocks in a laser detector according to an embodiment;

FIG. 6 to FIG. 9 are schematic diagrams of different arrangements of different blocks in laser detectors according to an embodiment;

FIG. 10 is a schematic diagram of an embodiment of a laser detector according to an embodiment; and

FIG. 11 is a schematic diagram of an embodiment of a LiDAR according to an embodiment.

### DETAILED DESCRIPTION

The following describes embodiments of the present application more specifically with reference to the accompanying drawings. Although the embodiments of the present application are shown in the accompanying drawings, it should be understood that the present application can be implemented in various forms.

The terms used in the embodiments of the present application are merely for purpose of illustrating specific embodiments. The singular forms of “a,” “the,” and “this” as used in the present application and the appended claims are also intended to include plural forms, unless the context clearly indicates otherwise. The term “and/or” used in this specification refers to any combination of one or more of the associated items listed and all possible combinations thereof.

Although the terms “first,” “second,” “third,” and the like are used to describe various types of information in the present application, the terms are only used to distinguish between information of the same type. For example, without departing from the scope of the present application, first information can also be referred to as second information, and similarly, second information can also be referred to as first information. Therefore, a feature with a determiner such as “first” or “second” can expressly or implicitly include one or more features. In the description of embodiments of the present application, “a plurality of” means two or more, unless otherwise specifically defined.

A LIDAR is a radar system that emits a laser beam to detect characteristics such as a position and a speed of a target. One working principle of the LiDAR is to emit a laser beam to the target detection region, and then calculate a time difference between a received reflected echo beam and the emitted laser beam, and the time difference is a time of flight of the laser beam. Based on the time of flight, the LiDAR calculates parameters such as a distance and azimuth of the object reflecting the echo beam, to detect an external environment. The LiDAR generally includes a transceiving module and a processing module. A laser emitter in the transceiving module converts an electrical pulse into an optical pulse for emission, and then a laser detector reversely converts an optical pulse reflected from the target into an electrical pulse signal, and the processing module calculates relevant information based on the electrical pulse signal. The LiDAR can also include a scanning module (for example, a MEMS galvanometer, a rotating mirror, and a mechanical rotary platform) for changing an emission direction of the emitted laser beam, so that the laser beam scans within a specific field of view. In an example, in which optical paths of an echo laser beam and an outgoing laser beam are coaxial, the echo laser beam returns via the same path from a scanning module to the transceiving module and is received by a laser detector in the transceiving module.

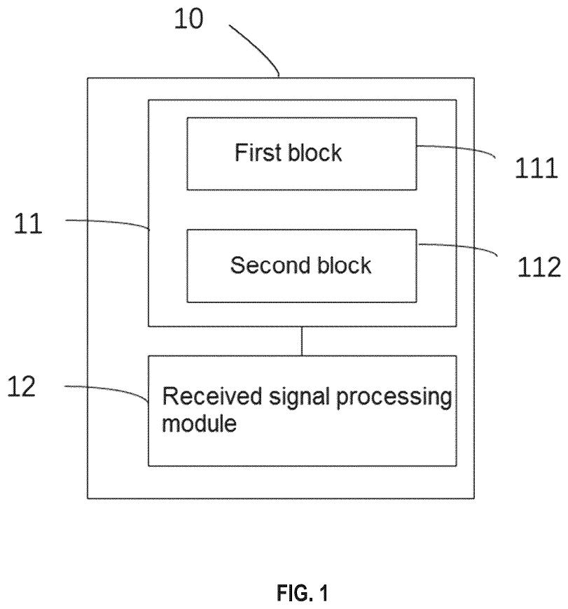

As shown in FIG. 1, FIG. 1 is a schematic diagram of an embodiment of a laser detector. A laser detector 10 includes multiple optical detection units 11 and a received signal processing module 12.

The multiple optical detection units include at least two blocks (a first block 111 and a second block 112), and each block includes at least one optical detection unit. A first bias voltage is input into each optical detection unit in the first block 111, and a second bias voltage different from the first bias voltage is input into each optical detection unit in the second block 112. The received signal processing module 12 is configured to process a received incident optical signal detected by the first block 111 and the second block 112 and provide an output signal.

In an example, the optical detection unit may include a single-photon avalanche diode (SPAD) array. A single-point SPAD works in Geiger mode and has large gains. Once triggered by a single photon, the single-point SPAD generates a large current signal. Therefore, the single-point SPAD has high photoelectric conversion efficiency, can detect excitation of the single photon, and is suitable for measurement of weak light, for example, detection of an echo from a long distance or in a case of low reflectivity.

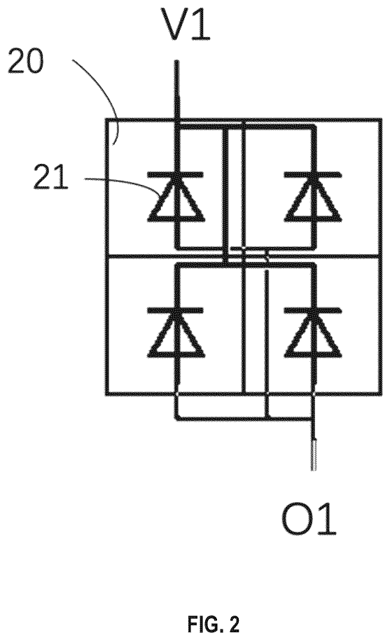

In an example, the block can be implemented by receiving different bias voltages input by a silicon photomultiplier (SiPM) block. As shown in FIG. 2, FIG. 2 is a schematic structural diagram of an SiPM. For an SiPM 20, multiple single-point SPAD micro-units 21 are connected in parallel under input of the same bias voltage V1 to generate an output O1. The output O1 is a combined signal triggered by multiple SPADs, and indicates a relationship between the number of SPADs triggered on a SiPM phase and time, and therefore, the SiPM is also referred to as a Multi-Pixel Photon Counter (MPPC). The output of the SiPM directly reflects optical intensity information of a detected optical signal. In the blocks in the multiple optical detection units, one block can be implemented via the SiPM, and different blocks can be implemented by receiving different bias voltages input by different SiPMs, or different blocks in the multiple optical detection units can be respectively implemented by dividing the SiPM into different blocks. In an embodiment, methods of applying a bias voltage to the SiPM can be applying the bias voltage through either the cathode or the anode.

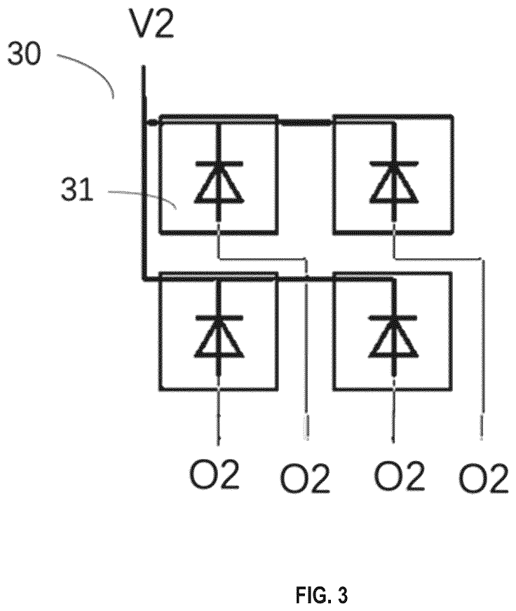

In an example, the block can be implemented via block combination of an output of the current SPAD array. As shown in FIG. 3, FIG. 3 is a schematic structural diagram of a SPAD array. A SPAD array 30 is an array formed by single-point SPADs 31. Under the same input of a bias voltage V2, each single-point SPAD has an independent output O2 and can only be triggered in response to a single photon. The output of the current SPAD array can be divided into at least two blocks, and outputs of different blocks are respectively combined to implement the SiPM respectively and serve as different blocks in the multiple optical detection units, or all the outputs of the SPAD array are combined to implement the SiPM and serve as one block in the multiple optical detection units.

The SiPM has high photoelectric conversion efficiency and single-photon gains, but a dynamic receiving range is also reduced. The number of SPADs in the SiPM determines the maximum number of photons that can be triggered, that is, the dynamic receiving range. The number of SPADs in the SiPM usually does not exceed 4000, and the dynamic range does not exceed 80 dB. To ensure a ranging capability for an object at a long distance or with low reflectivity, the 80 dB dynamic range is used to cover 80 dB of the weak light in a 160 dB dynamic range of reflected light. This means that in many cases where the reflected light is strong, SiPM enters a saturated state.

When the SiPM enters the saturated state, a series of problems are caused. Firstly, ranging performance is reduced. Once the SiPM is saturated, a detection capability is lost and the detection capability is gradually recovered within saturation recovery time. This means that when being irradiated by strong light, the SiPM experiences a sudden drop and a recovery process of the detection capability. Especially, for a LiDAR architecture with a coaxial optical path, because a stray light path cannot be avoided, there is leading reflected light. If the leading reflected light causes the SiPM to enter the saturation state, a blind region is caused for short-distance ranging. Secondly, reflectivities cannot be distinguished. If reflected light with different intensities can saturate the SiPM, it is difficult to distinguish the reflected light with the two intensities from the perspective of the intensities. The shorter the distance, the wider the range of indistinguishable reflectivities.

To prevent the SiPM from entering the saturated state during the short-distance ranging, an additional emission with small energy is usually introduced in addition to an emission with the maximum power. A smaller number of emitted photons means a smaller number of reflected echo photons, which can prevent the SiPM from entering the saturation state. This enables the SiPM to also have a detection capability for the short distance. However, because of the additional emission with the small energy, energy is consumed and time is wasted, thereby making a design of a transceiving sequence more complex and also making a design of a laser emission circuit more complex and expensive.

In the embodiments of this application, the multiple optical detection units are arranged in the laser detector, and the multiple optical detection units are arranged into at least two blocks with different input bias voltages. The block providing a higher bias voltage has higher photoelectric conversion efficiency and greater gains, and is suitable for measurement of weak light, for example, an echo from a longer distance or an echo with lower reflectivity. The block providing a lower bias voltage has lower photoelectric conversion efficiency and smaller gains, and is suitable for measurement of strong light, for example, an echo from a shorter distance or an echo with higher reflectivity. In this way, through the arrangement of the at least two blocks with different bias voltages, different detection efficiencies can be ensured and a greater dynamic detection range can be implemented. This also means that with the same laser emission power, the laser detector in this application can have a direct detection capability of a longer detection range at nighttime and greater approximation to a signal-to-noise ratio of light at daytime. In addition, the intensity of strong light can be better identified and distinguished, to better distinguish the reflectivities, especially, the reflectivity at the short distance. In addition, there is no need to introduce the emission with small energy in traditional short-distance ranging solutions, which can reduce energy consumption in single-point ranging, simplify the design of the transceiving sequence, and simplify the design of the laser emission circuit.

In an example, a bias voltage of at least one block in the laser detector is low enough to cause the block to degrade to work in the linear mode. Gains in the linear mode are in the order of 10 to 100, and therefore, excitation of thousands of photons is required to generate an electrical signal that can be detected by a subsequent circuit. The linear mode is suitable for detecting an echo from a short distance or an echo with a high reflectivity.

Three or more bias voltage levels can be set in the laser detector. Specific values of high and low bias voltages and selection of the number of levels depend on a system design requirement for receiving sensitivity and the dynamic range. Different numbers and types of block combinations can be established as required to implement different combination effects of dynamic ranges and resolution. More levels can cover a larger dynamic receiving range, thereby facilitating characteristic identification and processing of signals within the larger dynamic range by the rear end. Dynamic ranges of the levels are different. Different levels cover different dynamic ranges. There may be a specific link portion between the dynamic ranges of the different levels. The design of each level can be determined according to a post-processing requirement of the system.

In an example, the laser detector is further provided with a third bias voltage different from the first bias voltage and the second bias voltage, and includes a third block that inputs the third bias voltage. In an example, the first bias voltage is greater than the second bias voltage and the second bias voltage is greater than the third bias voltage. A saturation threshold of the first block to which the first bias voltage is input is lower than a saturation threshold of the second block to which the second bias voltage is input. That is, the second block still has a detection capability when the first block enters the saturated state. Likewise, the third block still has a detection capability when the second block enters the saturated state. Numbers of optical detection units in different blocks may be the same or different, and distribution densities may be the same or different. In an embodiment, the number of optical detection units in the first block is greater than the number of optical detection units in the second block. In an embodiment, the distribution density of the optical detection units in the first block is greater than the distribution density of the optical detection units in the second block. In an embodiment, the number of first blocks is greater than the number of second blocks.

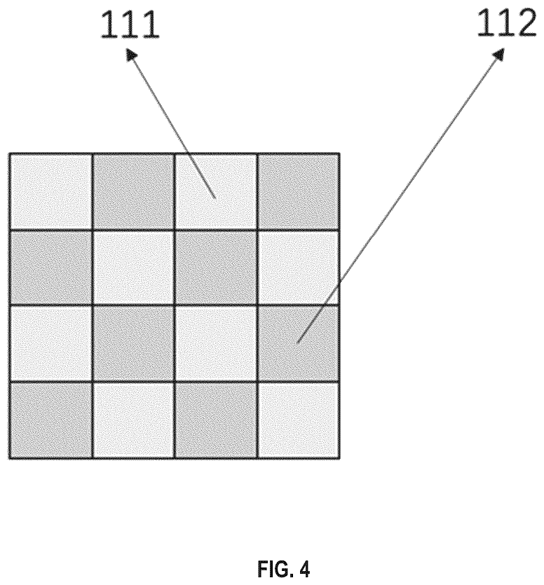

There are various arrangements of different blocks within the laser detector. For example, in multiple optical detection units, the blocks are alternately arranged, and input bias voltages of two adjacent blocks are different. As shown in FIG. 4, FIG. 4 is a schematic diagram of an arrangement of different blocks in a laser detector according to an embodiment. The multiple first blocks 111 and the multiple second blocks 112 are alternately arranged in rows and columns, and are generally evenly spaced, so that the blocks with two bias voltages are evenly distributed on a light receiving surface of the laser detector. Alternatively, the laser detector is provided with three blocks with different bias voltages, and the multiple first blocks, second blocks, and third blocks are alternately arranged in rows and columns to be generally evenly distributed on the light receiving surface.

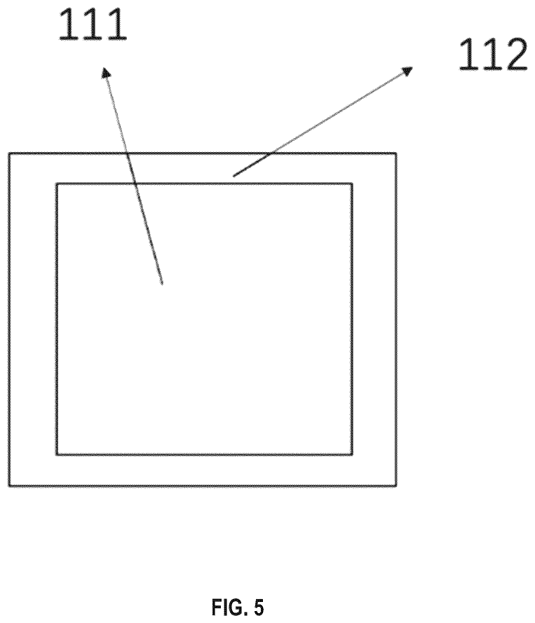

As shown in FIG. 5, FIG. 5 is a schematic diagram of an arrangement of different blocks in a laser detector according to an embodiment. The second bias voltage is lower than the first bias voltage, and the optical detection units in the second block 112 are arranged around the first block 111. Such a distribution solution integrates with the characteristic of optical imaging.

For most LiDARs, receiving sensors are generally placed at image points at infinite distances in the optical paths. For an echo from an object at a short distance, a point of focus is deviated, resulting in a larger light spot and greater crosstalk of the echo from the object in the near field. In the optical path, there are the following 2 causes of crosstalk: first, in a case of multi-channel transceiving, a main lobe of an imaging light spot falls on a receiver of a current channel, and a side lobe of the imaging light spot falls on a receiver of another channel due to a diffraction limit, thereby causing crosstalk to another channel; and second, the structure has a scattering effect on the echo light. In general, for the object with the low reflectivity, this part of echo light is very weak, and therefore, has small impact on the crosstalk. However, for the object with the high reflectivity, the echo is strong, and the echo at the edge of the light spot on the receiver can also be greater than the threshold, and therefore, is detected, thereby causing enormous crosstalk.

In this way, the block with a low bias voltage that can detect strong light is arranged on a periphery of the block with a high bias voltage that can detect weak light, and therefore, detection of weak light reflected by the object at the long distance or with the low reflectivity is not affected, and the block with the low bias voltage is basically not affected by ambient optical noise in the imaging light spot. In addition, in a scenario of the echo from the short distance that is likely to cause saturated strong light and a scenario of crosstalk of echo light with high reflectivity, the block with the low bias voltage on the periphery can receive a strong echo light signal under impact of the enlargement of the light spot and a side lobe of diffraction, which implements lower sensitivity and detection in the greater dynamic range, thereby compensating for a shortcoming of saturation of the block with the high bias voltage.

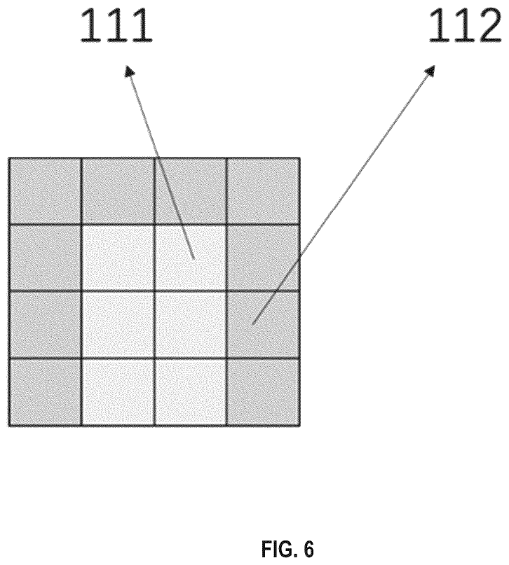

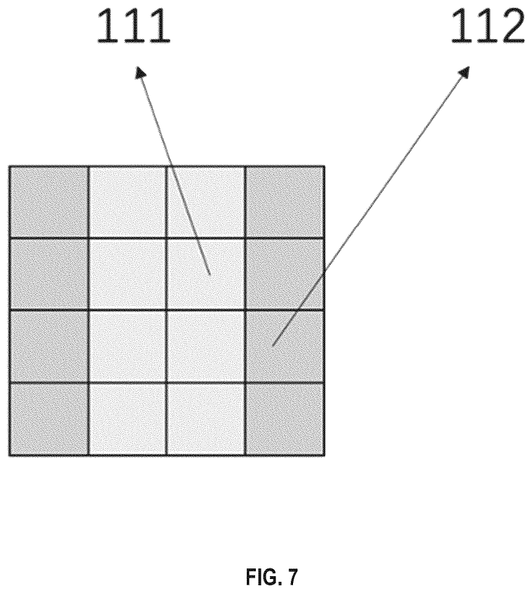

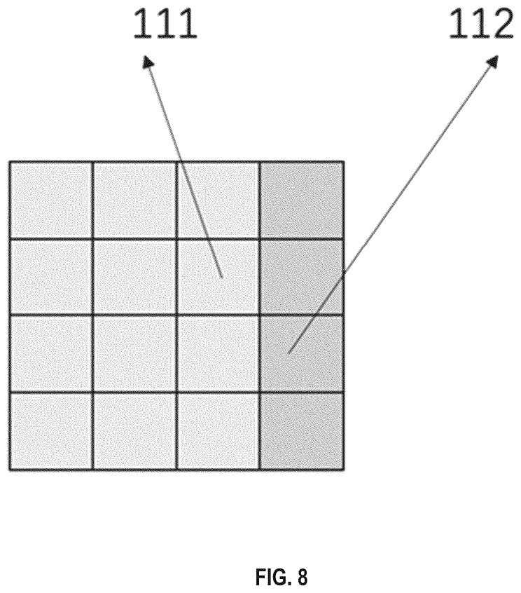

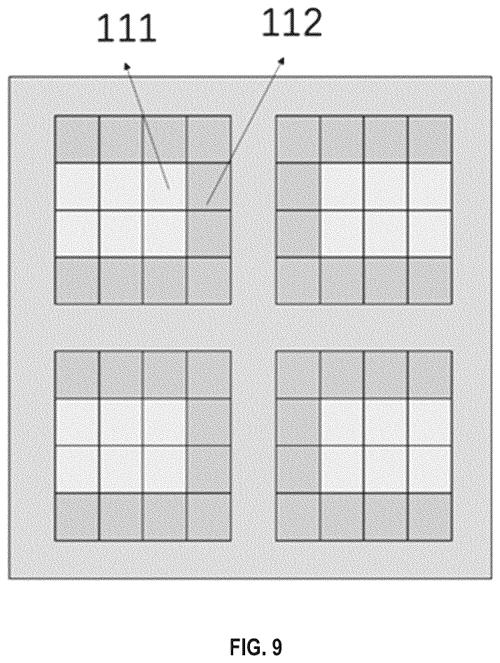

To simplify an actual manufacturing process, different blocks can be established by increasing the blocks with the low bias voltage on different sides. For example, as shown in FIG. 6 to FIG. 9, FIG. 6 to FIG. 9 are schematic diagrams of different arrangements of different blocks in laser detectors according to an embodiment. In FIG. 6, the second bias voltage is lower than the first bias voltage, and the optical detection units in the multiple second blocks 112 are respectively arranged on left, upper and right sides of the multiple first blocks 111. In FIG. 7, the second bias voltage is lower than the first bias voltage, and the optical detection units in the multiple second blocks 112 are respectively arranged on the left and right sides of the multiple first blocks 111. In FIG. 8, the second bias voltage is lower than the first bias voltage, and the optical detection units in the multiple second blocks 112 are respectively arranged on one side (the right side is used as an example in the figure) of the multiple first blocks 111. As shown in FIG. 9, the multiple SiPMs can be implemented on the same planar array to form a planar array of SiPMs. Arrangement of different blocks in any SiPM can be the same as that shown in any one of FIG. 6 to FIG. 8, or the same as the planar array of SiPMs including four SiPMs shown in FIG. 9. The second bias voltage is lower than the first bias voltage. In the two SiPMs on the left side, the optical detection units in the multiple second blocks 112 are respectively arranged on the upper, right and bottom sides of the multiple first blocks 111. In the two SiPMs on the right side, the optical detection units in the multiple second blocks 112 are respectively arranged on the left, upper, and bottom sides of the multiple first blocks 111. The planar array of SiPMs can be formed by SiPMs with the same or different structures, or even a new cross-SiPM block can be established. The planar array of SiPMs can be directly configured into blocks without first establishing separate SiPM subunits. When an SiPM block is designed on the planar array, the outputs of the blocks may be combined both inside of the SiPM subunit and across subunits. The planar array formed by SiPMs with different structures can be designed to meet specific needs of the system to achieve optimal performance.

In the multiple optical detection units of the laser detector, the blocks output signals to the received signal processing module in various output methods. The output methods in which the blocks output signals to the received signal processing module are described below by using examples. Arrangements of various blocks in the laser detector can be combined with the following output methods respectively.

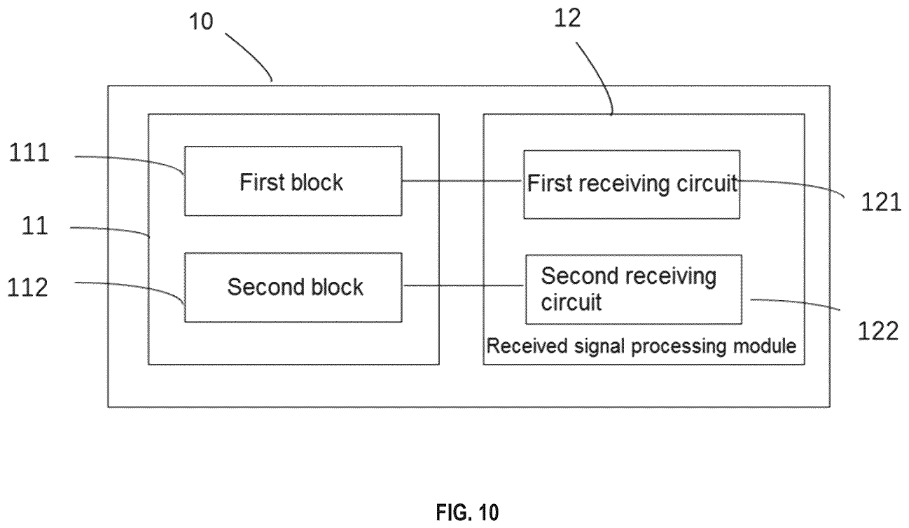

In an example, as shown in FIG. 10, FIG. 10 is a schematic diagram of an embodiment of a laser detector according to an embodiment. An input of the optical detection unit in the first block 111 is the first bias voltage, and the outputs are combined into the first detection signal for outputting. An input of the optical detection unit in the second block 112 is the second bias voltage, and the outputs are combined into the second detection signal for outputting. The received signal processing module 12 includes a first receiving circuit 121 for processing the first detection signal and a second receiving circuit 122 for processing the second detection signal. In an embodiment, the first bias voltage is higher than the second bias voltage, and when the first block outputs a saturated echo signal, the received signal processing module 12 obtains information of an echo signal via the second detection signal output by the second block by excluding the saturated echo signal output by the first block. Alternatively, the received signal processing module 12 obtains information of an echo signal via the second detection signal output by the second block and a rising edge and/or saturation width of the saturated echo signal output by the first block. Rising edge moment information and the saturation width of the saturated echo signal can be used to calculate reception time of the echo signal and reflectivity. However, the saturated signal with high resolution and in the low dynamic range loses a lot of waveform information, and it is difficult to extract identification features of abnormal waveforms, for example, echoes with crosstalk.

In an embodiment, the multiple optical detection units include multiple first blocks and multiple second blocks. All outputs of all the first blocks with the input of the first bias voltage are combined into the first detection signal for outputting, or all outputs of some first blocks with the input of the first bias voltage are combined into the first detection signal for outputting, and outputs of other first blocks with the input of the first bias voltage are combined into other detection signal for outputting. The same rule applies to the output of the second block.

For example, in the different blocks of the laser detector shown in FIG. 4, all outputs of the first block 111 are combined into one detection signal for outputting, or outputs of some first blocks 111 are combined into one detection signal for outputting, and outputs of the other first blocks 111 are combined into another detection signal for outputting.

In an example, an output of at least some optical detection units in the first block and an output of at least some optical detection units in the second block are combined into a third detection signal for outputting; and the received signal processing module includes a third receiving circuit for processing the third detection signal. Outputs of the blocks with different bias voltages can be combined with different weights to be output, to obtain a signal with both high resolution in the low dynamic range and low resolution in the high dynamic range. On the one hand, the number of outputs can be reduced and a design of a receiving and processing interface at a rear end is simplified. On the other hand, flexibility of the design is enhanced, which facilitates an extraction design of receiving features at different positions and with different intensities to fit the system.

For the blocks whose outputs are combined into one detection signal, outputs of two or more blocks at different bias voltages can be included. For example, outputs of at least some optical detection units in at least one third block are combined into a third detection signal, and an output of at least some optical detection units in the first block and an output of at least some optical detection units in the second block are jointly combined into a third detection signal for outputting. Alternatively, outputs of the optical detection units in the third block are combined into a fourth detection signal for outputting; and the received signal processing module includes a fourth receiving circuit for processing the fourth detection signal.

For example, different blocks in the laser detector shown in FIG. 4 are divided into at least two regions, and each region includes at least one first block and at least one second block. Outputs of blocks in each region are combined into the same detection signal for outputting, and outputs of different blocks in different regions are used as different detection signals for outputting.

In an example, the first block or the second block includes at least two sub-blocks, outputs of different sub-blocks are combined into different detection signals for outputting, and outputs of optical detection units in the same sub-block are combined into the same detection signal for outputting. Different sub-blocks in the same block can output signals independently, which can indicate intensity of echo light in different regions in the block, and can provide a region-related echo characteristic analysis for the rear end.

For example, optical detection units in a first block 111 in the laser detector shown in FIG. 5 are divided into at least two sub-blocks, and each sub-block includes at least one optical detection unit. For example, the first block 111 is divided in half into upper and lower sub-blocks, outputs of all optical detection units in each sub-block are combined into one detection signal for outputting, and outputs of different sub-blocks are used as different detection signals for outputting.

When the SiPM is included in the multiple optical detection units, a signal reading method for the SiPM can be reading from a higher side or a lower side. Reading a signal from a side of the SiPM closer to the GND is referred to as low-side reading. Reading a signal from a side of the SiPM that is farther away from the GND is referred to as high-side reading.

In the foregoing examples, when the outputs are combined into one detection signal for outputting, outputs of the blocks with to-be-combined outputs or some blocks can be directly combined into an excited current via a parallel connection, or after the pulse voltage is excited for the optical detection units with to-be-combined outputs, the outputs are combined through a logic combination circuit or an analog superposition method. For example, after the excited current of the optical detection unit is converted into a pulse signal, conditional screening and combination is performed via the AND-OR gate circuit, or the pulse signal is further subjected to analog circuit addition to be combined.

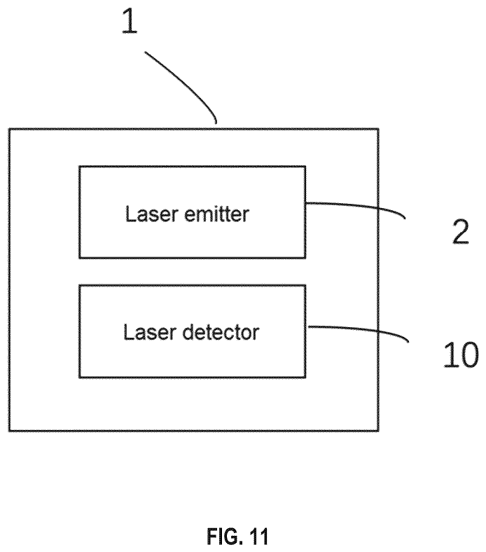

An embodiment of this application further provides a LIDAR. As shown in FIG. 11, FIG. 11 is a schematic diagram of an embodiment of a LiDAR according to an embodiment of this application. The LiDAR 1 includes a laser emitter 2 for emitting a laser beam, and the foregoing laser detector 10. It can be understood that, as an embodiment, the LiDAR may also include a scanning member, where the scanning member may be, for example, a galvanometer, a rotating mirror, or a mechanical rotary platform. This application imposes no limitation on whether the LiDAR includes the scanning member.

The embodiments of the present application are described above, but the above description is exemplary other than exhaustive, and is not limited to the disclosed embodiments. Various modifications and alterations shall be evident to a person skilled in the art without departing from the scope and spirit of the described embodiments. The terms used herein are intended to optimally explain the principle of each embodiment, actual application or improvement of technologies in the art, or help other persons skilled in the art understand the embodiments disclosed herein.

What is claimed is:

1. A laser detector, comprising multiple optical detection units and a received signal processing module, wherein:
the multiple optical detection units are divided into at least a first block and a second block, a first bias voltage is input into each optical detection unit in the first block, a second bias voltage is input into each optical detection unit in the second block, and the first bias voltage is different from the second bias voltage; and
the received signal processing module is configured to process a received incident optical signal detected by the first block and the second block and to provide an output signal.

2. The laser detector according to claim 1, wherein outputs of the optical detection unit in the first block are combined into a first detection signal for outputting, and outputs of the optical detection unit in the second block are combined to output a second detection signal; and
wherein the received signal processing module comprises a first receiving circuit for processing the first detection signal and a second receiving circuit for processing the second detection signal.

3. The laser detector according to claim 2, wherein the first bias voltage is higher than the second bias voltage, and when the first block outputs a saturated echo signal, the received signal processing module obtains information of an echo signal via the second detection signal output by the second block by excluding the saturated echo signal output by the first block.

4. The laser detector according to claim 2, wherein the first bias voltage is higher than the second bias voltage, and when the first block outputs a saturated echo signal, the received signal processing module obtains information of an echo signal via the second detection signal output by the second block and a rising edge and/or saturation width of the saturated echo signal output by the first block.

5. The laser detector according to claim 1, wherein an output of at least some optical detection units in the first block and an output of at least some optical detection units in the second block are combined into a third detection signal for outputting; and the received signal processing module comprises a third receiving circuit for processing the third detection signal.

6. The laser detector according to claim 1, wherein the multiple optical detection units further are divided into a third block, a third bias voltage is input into each optical detection unit in the third block, and the third bias voltage is different from the first bias voltage and the second bias voltage;
wherein outputs of optical detection units in the third block are combined into a fourth detection signal for outputting; and
wherein the received signal processing module comprises a fourth receiving circuit for processing the fourth detection signal.

7. The laser detector according to claim 1, wherein the first block or the second block comprises at least two sub-blocks, outputs of different sub-blocks are used as different detection signals for outputting, and outputs of optical detection units in a same sub-block are combined into a same detection signal for outputting.

8. The laser detector according to claim 1, wherein optical detection units in a same block are connected in parallel to combine outputs into a detection signal and output the detection signal to a receiving circuit.

9. The laser detector according to claim 1, wherein the optical detection units in a same block convert their respective excited currents into pulse signals, combine the pulse signals into a detection signal via a logic combination circuit, and output the detection signal to a receiving circuit.

10. The laser detector according to claim 1, wherein optical detection units in a same block convert their respective excited currents into pulse signals, combine the pulse signals into a detection signal via analog circuit addition and output the detection signal to a receiving circuit.

11. The laser detector according to claim 1, wherein the multiple optical detection units are divided into multiple blocks, and input bias voltages of two adjacent blocks are different.

12. The laser detector according to claim 1, wherein the second bias voltage is lower than the first bias voltage, and the optical detection units in the second block are arranged around the first block.

13. The laser detector according to claim 1, wherein the second block and the first block are arranged side by side.

14. The laser detector according to claim 1, wherein the second bias voltage is lower than the first bias voltage, the laser detector comprises at least two second blocks, and the at least two second blocks are respectively arranged on different sides of the first block.

15. The laser detector according to claim 1, wherein the multiple optical detection units comprise a silicon photomultiplier (SiPM) array or a single-photon avalanche diode (SPAD) array.

16. A LIDAR, comprising:
a laser emitter for emitting a laser beam and a laser detector, wherein the laser detector comprises multiple optical detection units and a received signal processing module, wherein:
the multiple optical detection units are divided into at least a first block and a second block, a first bias voltage is input into each optical detection unit in the first block, a second bias voltage is input into each optical detection unit in the second block, and the first bias voltage is different from the second bias voltage; and
the received signal processing module is configured to process a received incident optical signal detected by the first block and the second block and to provide an output signal.
